(19) United States
(12) Patent Application Publication
(10) Pub. No.: US 2026/0086854 A1
(43) Pub. Date: Mar. 26, 2026

(54) DETERMINING RESOURCE ALLOCATIONS FOR MICROSERVICE-BASED APPLICATIONS

(71) Applicant: HEWLETT PACKARD ENTERPRISE DEVELOPMENT LP, Spring, TX (US)

(72) Inventors: Lianjie Cao, Milpitas, CA (US); Faraz Ahmed, Milpitas, CA (US); Hana Khamfroush, Campbell, CA (US); Puneet Sharma, Milpitas, CA (US)

(21) Appl. No.: 18/894,478

(22) Filed: Sep. 24, 2024

(51) Int. Cl. G06F 9/50; G06F 9/455

(52) U.S. Cl. CPC G06F 9/5027; G06F 9/45558; G06F 2009/45595

(57) ABSTRACT

A technique includes associating requests to an application with respective target Quality-of-Experience (QoE) metric values. Associating the request includes associating each request with a QoE metric value based on a request category associated with the request. The application includes microservices, and the microservices are to be hosted on respective nodes. The technique includes evaluating candidate resource allocations for the application. Each candidate resource allocation includes a resource allocation for the plurality of nodes, and evaluating the candidate resource allocations includes determining associated predicted QoE metric values for each candidate resource allocation. The technique includes selecting a candidate resource allocation based on the associated predicted QoE metric values and the target QoE metric values.

### BACKGROUND

In one type of application architecture, an application may be monolithic and correspond to a single unit. In another type of application architecture, an application may be formed from multiple, autonomous parts called “microservices.” As compared to the monolithic architecture, the microservice architecture provides greater scalability, flexibility and improved manageability. Moreover, the microservice architecture may be better suited for cloud deployment of an application.

### BRIEF DESCRIPTION OF THE DRAWINGS

FIG. 1 is a block diagram of a computer network that includes an application resource allocation service to determine compute node placements for microservices and resource allocations for the compute nodes, according to an example implementation.

FIG. 2 is an illustration of an architecture to determine an application resource allocation based on target Quality-of-Experience (QoE) metric values for different application request categories, according to an example implementation.

FIGS. 3A and 3B depict a flow diagram of a technique to determine an application resource allocation based on target QoE metric values for different application request categories, according to an example implementation.

FIG. 4 is a flow diagram depicting a technique to determine resource allocations for nodes that host microservices based on target QoE metric values for different application request categories, according to an example implementation.

FIG. 5 is an illustration of a non-transitory storage medium that stores hardware processor-readable instructions that, when executed by a hardware processor, cause an application resource allocation engine to determine resource allocations for nodes that host microservices based on target QoE metric values for different application request categories, according to an example implementation.

FIG. 6 is a block diagram of a system that includes an application resource allocation engine to determine resource allocations for nodes that host microservices based on target QoE metric values for different application request categories, according to an example implementation.

### DETAILED DESCRIPTION

Unlike an application that has a monolithic design, a microservice-based application is decomposed into finer-grained components, or microservices, which can each be deployed and scaled independently. A microservice-based application may be deployed as an orchestrated container cluster (e.g., a KUBERNETES cluster or a DOCKER SWARM cluster). An orchestrated container cluster has an orchestrator that manages the lifecycles and workloads of the environment's containers. In examples, an orchestrator may manage container replication, when containers start and stop, container scaling, workload distribution among the containers, or other lifecycle phase or workload aspects of the container environment. An orchestrated container cluster has a control plane and worker nodes.

The microservices of a microservice-based application may be deployed on respective compute nodes (e.g., worker nodes) of an orchestrated container cluster. In an example, a container that corresponds to a particular microservice and contains one or multiple pods (e.g., pods corresponding to different instances of the microservice) may be deployed on a particular compute node. The compute nodes may be part of a distributed system and may be associated with one or multiple computing environments, such as an edge computing environment, a private cloud, a public cloud, a hybrid cloud, or a combination thereof.

A compute node may be virtual (e.g., correspond to a virtual machine) or physical (e.g., correspond to a bare-metal environment). Regardless of whether a compute node is virtual or physical, the compute node has an associated set of resources, which support the workloads (e.g., application processes) of the hosted microservice. A virtual compute node has associated virtual resource allocations, such as a number of virtual processing cores (e.g., virtual central processing unit (CPU) cores and/or virtual graphics processing unit (GPU) cores), an amount of virtual memory and an amount of virtual storage. A physical compute node has associated physical resource allocations, such as a number of physical processing cores, an amount of physical memory and an amount of physical storage.

For purposes of deploying a microservice-based application, a determination is first made regarding an assignment of resources to the application, which is referred to as an “application resource allocation” herein. An application resource allocation may specify compute node placements for the microservices (e.g., whether to host a particular microservice on a compute node located in a particular private cloud, public cloud or edge computing system), and the application resource allocation may further specify resource allocations for the respective compute nodes. In an example, compute node A may be assigned to a particular microservice of the application and be allocated 5 CPU cores, 500 megabytes (MB) of memory and 5 gigabytes (GB) of storage; compute node B may be assigned to another microservice of the application and be allocated 4 CPU cores, 200 MB of memory and 3 GB of storage; and so forth.

An application resource allocation may be constrained by two competing goals. The first goal is that the compute nodes are assigned adequate resources so that the execution of the application satisfies certain performance criteria. The second goal is that the compute nodes are not over-provisioned, so that the costs of the resource provider(s) (e.g., a cloud service provider) are limited. Determining an appropriate application resource allocation may be a complicated and error-prone task due to a variety of factors. In examples, such factors may include varying complexities of the application's microservices; varying input/output (I/O) transaction times and communication bandwidths for different computing environments; microservice scaling differences; and varying compute node resource constraints. Approaches to determining appropriate application resource allocations may rely on orchestration rules and policies. Moreover, approaches to determining application resource allocations may rely on input about complex underlying features of the application, such as input specifying the detailed resource requirements for the microservice instance and the desired application states. In general, these approaches depend on detailed knowledge about the inner workings of the application.

An application resource allocation service, in accordance with example implementations, determines compute node placements for microservices and determines resource allocations for the compute nodes based on Quality-of-Experience (QoE) metric goals, or targets. In the context that is used herein, a “QoE metric” generally refers to a measurable performance of the application, as perceived or observed by an end user of the application. A QoE metric “target,” in the context that is used herein, refers to an expected value for the QoE metric. As such, a QoE metric target is also referred to herein as a “target QoE metric value.”

More specifically, in accordance with example implementations, the application resource allocation service considers target QoE metric values for requests (also called “application requests” herein) that are processed by the application. In this context, a “request” generally refers to an input that is received by an application and causes the application to process, or serve, the request and provide a response, or output. Processing, or serving, a request may involve one or multiple microservices of the application processing, or serving, the request; and different requests may involve different sets of microservices and different microservice-to-microservice communications. In an example, a QoE metric corresponds to a processing latency for the application, and a corresponding target QoE metric value represents a maximum threshold for the processing latency. In another example, a QoE metric corresponds to a throughput for the application, and a corresponding target QoE metric value represents a minimum threshold for the throughput.

The application resource allocation service, in accordance with example implementations, recognizes that the number of microservices and the number of microservice interactions involved in serving a particular request depend on a category, or type, of the request. In an example, an online e-commerce application that provides an online store includes, among other possible microservices, a front-end microservice to provide a customer interface (e.g., provide a graphical user interface (GUI)), a catalog microservice to manage an available inventory of items, a payment microservice to manage purchases of products, and a shipping microservice to manage shipping of purchased products. In an example of request categories for the online e-commerce application, a browse product request category includes requests that are related to customers navigating the online store, and a checkout request category includes requests that are related to customers purchasing items. In an example, requests corresponding to the browse product request category may trigger processing by a subset of the e-commerce application's microservices, whereas request corresponding to the checkout request category may trigger processing by all of the online e-commerce application's microservices.

In accordance with example implementations, an application resource allocation service considers a set of requests (e.g., all potential requests) that may be served by a microservice-based application. For purposes of determining an application resource allocation for the application, target QoE metric values for different request categories are provided to the application resource allocation service as inputs. In an example, the inputs may be provided by a cloud service operator, who is committed to provide services to users (e.g., shoppers for an e-commerce application) of the application with certain QoE levels. For each candidate application resource allocation, the application resource allocation service predicts, or estimates, QoE metric values produced by the application serving the respective requests of the set of requests. As described further herein, the application resource allocation service evaluates the candidate application resource allocations based on the estimated QoE metric values and the target QoE metric values. In accordance with example implementations, the application resource allocation service selects the candidate application resource allocation that best satisfies the target QoE metric values without over-provisioning the compute nodes. Among the potential advantages, compute node placements and compute node resource allocations are determined based on target QoE metric values and without relying on knowledge of complex inner workings of the application.

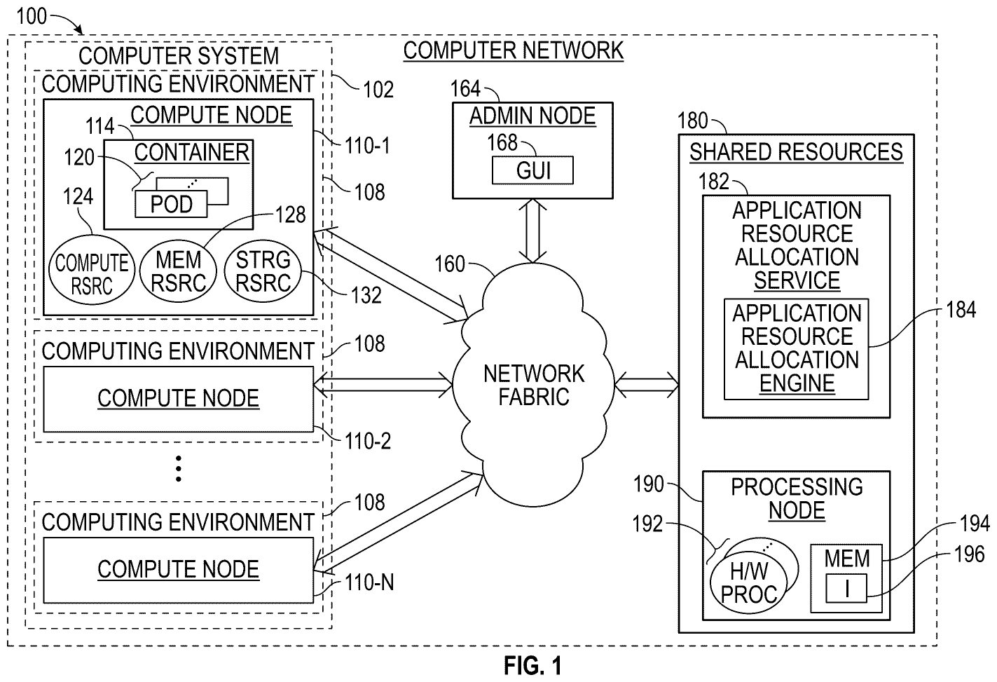

In a more specific example, FIG. 1 depicts a computer network 100 in accordance with some implementations. The computer network 100 includes a computer system 102 (e.g., a distributed system) that hosts microservices of a microservice-based application. In accordance with example implementations, the microservices are hosted by N compute nodes 110 (compute nodes 110-1, 110-2 and 110-N being specifically depicted in FIG. 1) of an orchestrated container cluster (e.g., a KUBERNETES cluster or a DOCKER SWARM cluster). The orchestrated container cluster may further include control plane components, which are not depicted in FIG. 1. FIG. 1 depicts specific components of the compute node 110-1. The other compute nodes 110 may each have similar components to the compute node 110-1, in accordance with example implementations.

As depicted in FIG. 1, each compute node 110 is associated with a particular computing environment 108. In an example, multiple compute nodes 110 may be deployed in the same computing environment 108. In another example, all compute nodes 110 may be deployed in the same computing environment 108. In another example, the compute nodes 110 may be deployed in multiple computing environments 108, corresponding to different computing environment categories, or types. A computing environment 108, in accordance with example implementations, may correspond to a private cloud, a public cloud, a hybrid cloud, an edge computing system or a combination of one or multiple of the foregoing environments. In an example, a particular computing environment 108 may be a private or hybrid cloud that also corresponds to an edge computing system. In the context that is used herein, a “cloud” refers to a computer system that is associated with resources that can be scaled up and down on demand.

In a more specific example, a particular computing environment 108 is a private cloud that is managed by a business entity and has on-premise resources that are located in the business entity's private datacenter, are located in leased space of a co-location datacenter, or some combination thereof. In another example, a particular computing environment 108 is a hybrid cloud that has on-premise resources that are managed by a public cloud operator. In another example, a particular computing environment 108 is a public cloud. In another example, a particular computing environment 108 corresponds to the network edge and provides network connectivity for edge devices as well as providing one or multiple other services (e.g., edge storage or edge compute services). In an example, all of the compute nodes 110 are located in the same private cloud. In other examples, all of the compute nodes 110 are located in the same public cloud or in the same hybrid cloud. In another example, the compute nodes 110 are distributed across multiple clouds of potentially different cloud types and are associated with multiple geographical locations.

A given compute node 110 may be virtual or physical. In an example, all of the compute nodes 110 are virtual, and in another example, all of the compute nodes are physical. In another example, some compute nodes 110 are virtual, and the remaining compute nodes 110 are physical. A compute node 110 being “virtual” refers to the compute node 110 having virtual resources. In an example, the compute node 110-1 is virtual and has virtual compute resources 124 (e.g., virtual CPU cores and/or virtual GPU cores), virtual memory resources 128 (e.g., an amount of assigned virtual random access memory (RAM)). In another example, a server (e.g., an enclosure-based server, such as a blade server; a rack-based server, such as a density line (DL) server; or a tower server) has physical compute, memory and storage resources that are abstracted by a hypervisor of the server, and a compute node 110 corresponds to a virtual machine that is hosted by the server.

A compute node 110 being “physical” refers to the compute node 110 having unabstracted access to physical resources. In an example, the compute node 110-1 is a physical node and has physical compute resources 124, physical memory resources 128 and physical storage resources 132. In examples, a physical compute node 110 corresponds to a server, such as the entire server or a bare-metal environment corresponding to certain physical resources of the server.

A compute node 110 may have resources other than the compute resources 124, memory resources 128 and storage resources 132 that are depicted in FIG. 1. In an example, a compute node 110 also has compute, memory and storage resources as well as network resources. In another example, a compute node 110 has compute and memory resources but does not have storage resources.

The compute nodes 110 are connected by network fabric 160. In accordance with example implementations, the network fabric 160 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

In accordance with example implementations, each microservice corresponds to a compute node 110 and runs in a respective container (e.g., a container 114 of compute node 110-1) that is allocated to and started on the compute node 110. As depicted in FIG. 1, a container 114 of the compute node 110-1 has container pods 120. In an example, the container 114 corresponds to a microservice, and each container pod 120 within the container 114 corresponds to an instance of the microservice.

FIG. 1 depicts the computer system 102 after the deployment of the microservice-based application. Before the deployment, an application resource allocation service 182 may be used to determine an application resource allocation for the application. The application resource allocation service 182 specifies compute node placements for the application's microservices and further specifies resource allocations for the compute nodes 110. In an example, the application resource allocation service 182 is provided by shared resources 180. In an example, the shared resources 180 may correspond to a public cloud, and the application resource allocation service 182 may be an “as-a-Service” that is provided by a cloud service operator. In an example, a person associated with a cloud service operator may, via a GUI 168 of an administrative node 164, provide input data to the application resource allocation service 182. The application resource allocation service 182 uses the input data to determine compute node placements for the microservices and determine resource allocations for the compute nodes 110. In accordance with example implementations, as depicted in FIG. 1, the administrative node 164 is connected to the network fabric 160. In an example, the administrative node 164 may be a server. In an example, the input data may represent target QoE metric values for different respective application request types, or categories.

The application resource allocation service 182 includes an application resource allocation engine 184 that evaluates candidate application resource allocations based on the provided target QoE metric values. The candidate application resource allocations correspond to the permutations of potential compute node placements and compute node resource allocations. As described herein, the application resource allocation service 182 constrains the candidate application resource allocations so that none of the candidate application resource allocations result in over-provisioning of the compute nodes 110.

As described further herein, in accordance with example implementations, the application resource allocation engine 184 evaluates a candidate application resource allocation by predicting, or estimating, a QoE metric value (also called an “estimated QoE metric value” or “predicted QoE metric value”) for each request of a set of potential requests served, or processed, by the application. The target QoE metric value for a given request corresponds to the target QoE metric value that is assigned to the request's request category. The application resource allocation engine 184 determines, for each request, a difference between the estimated QoE metric value and the target QoE metric value. The application resource allocation engine 184 determines, for each candidate application resource allocation, a summation of the differences between the estimated QoE metric values and the corresponding target QoE metric values. The summation of differences represents a degree of compliance of the candidate application resource allocation with the target QoE metric values.

The application resource allocation engine 184, in accordance with example implementations, selects the candidate application resource allocation that has the highest degree of compliance with the target QoE metric values (e.g., selects the candidate application resource allocation that has the minimum associated summation of differences). The application resource allocation engine 184 may then take one or multiple further actions based on the selected application resource allocation. In an example, a further action includes the application resource allocation engine 184 providing data to the GUI 168 that causes the GUI 168 to display selected application resource allocation (e.g., display compute node placements for the microservices and compute node resource allocations). In another example, a further action includes the application resource allocation engine 184 deploying containers (e.g., container 114) to the compute nodes 110 and starting the containers. Each container contains one or multiple container pods (e.g., the container pods 120), which correspond to respective microservice instances.

Among its other features, in accordance with example implementations, the shared resources 180 include one or multiple processing nodes 190. In an example, a processing node 190 may be a computer platform, such as a blade server, a rack server, a tower server, or other processor-based electronic device. Regardless of its particular form, the processing node 190 includes one or multiple hardware processors 192 and a memory 194. In an example, a hardware processor 192 may include one or multiple central processing unit (CPU) cores and/or one or multiple graphics processing unit (GPU) cores. In another example, a hardware processor 192 may include one or multiple semiconductor CPU packages (or “sockets”).

The memory 194 includes non-transitory storage media that may be formed from semiconductor storage devices, memristor-based storage devices, magnetic storage devices, phase change memory devices, a combination of devices or one or more of these storage technologies, and so forth. The memory 194 may represent a collection of memories of both volatile memory devices and non-volatile memory devices.

In an example one or multiple hardware processors 192 on one or multiple processing nodes 190 may execute machine-readable instructions, such as machine-readable instructions 196 that are stored in the memory 194, for purposes of providing the application resource allocation engine 184 and correspondingly providing the application resource allocation service 182. In accordance with further implementations, a hardware processor 192 may be a hardware circuit that does not execute machine-executable instructions, such as an application specific integrated circuit (ASIC), field programmable gate array (FPGA), programmable logic device, a programmable logic device (PLD), or other hardware dedicated to providing one or multiple functions for the application resource allocation engine 184. In accordance with further implementations, a hardware processor 192 may be a combination of a hardware circuit that does not execute machine-executable instructions and a processing circuit that executes machine-readable instructions.

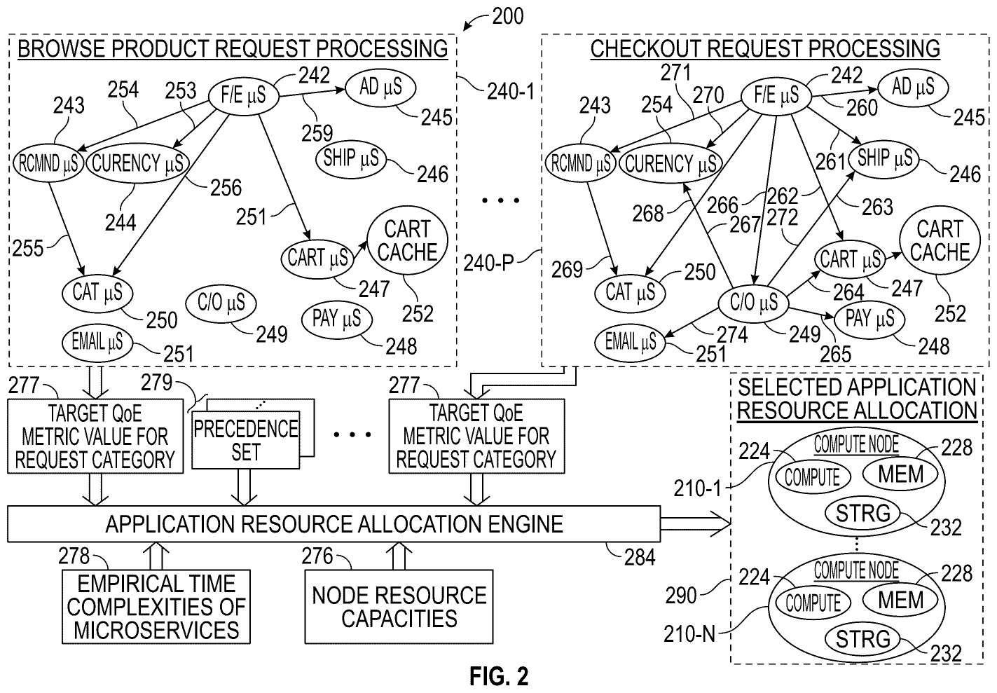

FIG. 2 illustrates an architecture 200 to determine an application resource allocation 290 (or “selected application resource allocation 290”) in accordance with example implementations. Referring to FIG. 2, the application resource allocation 290 includes a set of N compute nodes 210 (compute nodes 210-1 and 210-N being depicted in FIG. 2). Each compute node 210 has an associated collection of resources, such as compute 224, memory 228 and storage 232 resources. Although not depicted in FIG. 2, the application resource allocation 290 further specifies specific compute node placements for respective microservices. The architecture 200 includes an application resource allocation engine 284, which corresponds to the application resource allocation engine 184 of FIG. 1.

FIG. 2 depicts an exemplary application for an online e-commerce store. The application has ten microservices 242-251. A front-end microservice 242 serves as a web server to provide a GUI for customers. A catalog microservice 250 provides an inventory of available products and provides search features to allow customers to find specific products. A payment microservice 248 handles payment processing (e.g., handles credit card transactions and debit card transactions) for purchases. A shipping microservice 246 provides shipping estimates and manages the shipping of purchased products to customers. An advertisement microservice 245 provides advertisements based on customer activity. A shopping cart microservice 247 stores and retrieves products in a shopping cart cache 252 (corresponding to the customer's shopping cart). A checkout microservice 249 retrieves products from the cart cache 252 and coordinates shipping and payment. An email microservice 251 sends out order confirmation and shipping emails. A recommendation microservice 243 provides product recommendations based on viewed and purchased products.

The application resource allocation engine 284 considers target QoE metric values 277 for P respective request categories 240. FIG. 2 depicts two specific exemplary request categories 240: a request category 240-1 (called the “browse products category 240-1” herein) that includes requests associated with browsing the online e-commerce store; and a request category 240-P (called the “checkout category 240-P” herein) that includes requests associated with the checkout of products.

A request of the browse products category 240-1 triggers processing of up to six microservices 242, 243, 244, 245, 247 and 250 of the application. FIG. 2 depicts edges 251, 253, 254, 255, 256 and 259 representing communication dependencies among the six microservices that serve requests of the browse products category 240-1. In an example, a request A of the browse products category 240-1 is directed to a search inquiry based on a customer-provided search string. The request A is received by the front-end microservice 242. In response to request A, the front-end microservice 242, as depicted by edge 256, communicates with the catalog microservice 250 to search the catalog based on the search string and display a list of results resulting from the search. The front-end microservice 242, corresponding to the edge 253, communicates with the currency microservice 244 to perform currency conversion so that the displayed prices correspond to the currency of the customer. Moreover, in response to the request A, the front-end microservice 242, corresponding to the edge 259, communicates with the advertising microservice 245 to display an advertisement based on the customer's browsing activity.

In another example, a request B of the browse products category 240-1 is directed to adding a displayed and selected product to the shopping cart cache 252. In response to request B, the front-end microservice 242, corresponding to the edge 251, communicates with the cart microservice 247 to add the product to the shopping cart cache 252.

A request of the checkout category 240-P triggers processing of up to all ten microservices 242-251 of the application. FIG. 2 depicts edges 260-272 and 274 representing communication dependencies among the ten microservices 242-251 for requests of the checkout category 240-P. In an example, a request C of the checkout category 240-P is directed to selection of a product in the cart cache 252 for checkout. The request C is received by the front-end microservice 242. In response to the request C, the front-end microservice 242, as depicted by the edge 266, communicates with the checkout microservice 249 to prepare the order for checkout. As depicted by the edge 264, the checkout microservice 249 communicates with the cart microservice 247 to retrieve the product(s) from the cart cache 252. Moreover, as depicted by the edge 267, the checkout microservice 249 may communicate with the currency microservice 254 to convert the price(s) of the product(s) into the currency of the customer, and as depicted by the edge 272, the checkout microservice 249 communicates with the shipping microservice 246 for purposes of receiving a shipping cost for the order.

In another example, a request D of the checkout category 240-P is directed to confirming the purchase of an order. The request D is received by the front-end microservice 242. In response to the request D, the front-end microservice 242, as depicted by the edge 266, communicates with the checkout microservice 249 to confirm the purchase and finalize checkout. As depicted by the edge 265, the checkout microservice 249 communicates with the payment microservice 248 to process payment and provide a corresponding transaction ID. As depicted by the edge 272, upon successful payment, the checkout microservice 249 communicates with the shipping microservice 246 to perform the actions to initiate shipping of the purchased product(s). Moreover, as depicted by the edge 274, the checkout microservice 249 communicates with the email microservice 251 to send out an order confirmation email to the customer.

In addition to the target QoE metric value 277 for each request category 240, the application resource allocation engine 284 receives other inputs, such as node resource capacities 276, empirical time complexities 278 of the microservices and precedence sets 279. The node resource capacities 267 specify the resource limits for each compute node 210. In an example, a particular compute node 210 may correspond to a virtual machine that has up to 10 available virtual CPU cores, up to 500 MB of virtual memory and up to 7 GB of virtual storage, and the node resource capacities 267 specify these limits for the particular compute node 210. The empirical time complexities 278 specify an input complexity for each microservice, which is a measure of the microservice's complexity and is used to estimate a processing time for each microservice. In accordance with example implementations, the application resource allocation engine 284 calculates a processing time for a microservice to serve a request based on its empirical time complexity 278 and a transfer time for the microservice to provide its output to the next successor microservice. As described further herein for a specific example, the application resource allocation engine 284 estimates a QoE metric value for a particular request based on the processing and transfer times.

The precedence sets 279 are associated with respective requests. Each precedence set 279 represents the processing flows among the microservices that process, or serve, the request. More specifically, in accordance with example implementations, the precedence sets 279 may be derived as follows. Each request is depicted as a directed graph Gᵣ(Vᵣ, Eᵣ). In this representation, “r” represents a request index corresponding to a specific request, and the vertex set “Vᵣ” symbolizes the set of microservices involved in processing, or serving, the request r. Also in this representation, “Eᵣ” represents the set of directed edges that convey the order of execution dependencies among the microservices in processing, or serving, the request.

The directed graph G (Vᵣ, Eᵣ) may be represented by a |Vᵣ|×|Vᵣ| adjacency matrix, called the “Aᵣ adjacency matrix” herein. The Aᵣ adjacency matrix has a row index i, where different values of i correspond to respective microservices of the set of microservices that serve the request r, and the Aᵣ adjacency matrix has a column index j, where different values of j correspond to respective microservices of the set of microservices that serve the request r. In an example, for a request in which five microservices serve the request, the Aᵣ adjacency matrix has 5 rows that correspond to the respective five microservices, and likewise, the Aᵣ adjacency matrix has 5 columns that correspond to the respective five microservices. The ij-th element Aᵣ(i, j) of the Aᵣ adjacency matrix is a “1” if microservice i depends on microservice j, which means that the i-th microservice of request r can be executed only when the execution of the j-th microservice of request r is completed. Otherwise, the ij-th element Aᵣ(i, j) of the Aᵣ adjacency matrix is a “0” if microservice i does not depend on microservice j.

For each request r, the last microservice that processes, or serves, the request r does not have any outgoing edge. Therefore, the column associated with the last microservice in the adjacency matrix Ar has all zeros. Moreover, for each request r, the first microservice that serves the request r does not have any incoming edge. Therefore, the row associated with the first microservice in the adjacency matrix Ar has all zeros. Each microservice i of request r, has an associated precedence set Pir, which is defined as Pir={j|Ar(i, j)=1}.

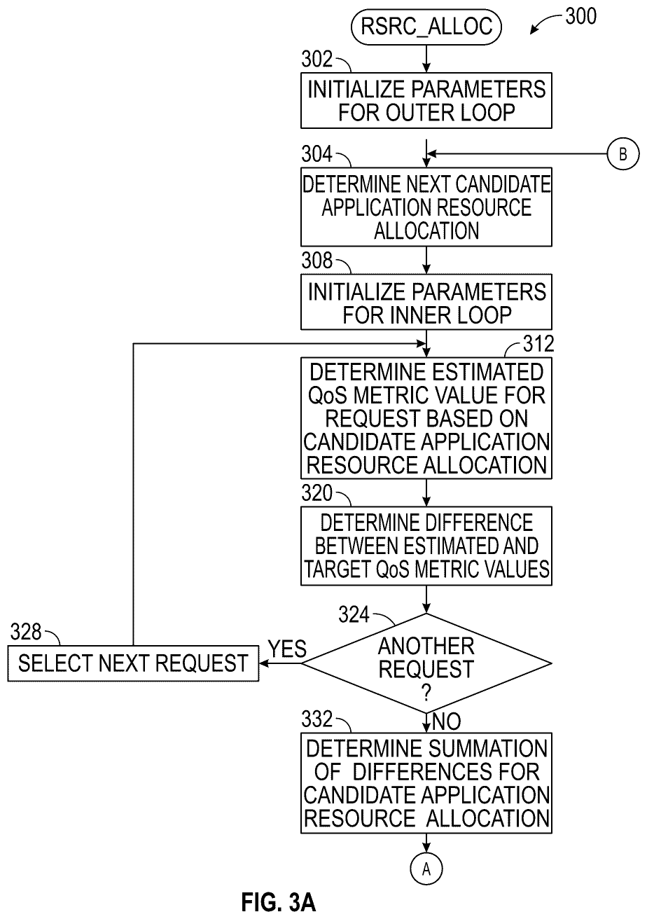

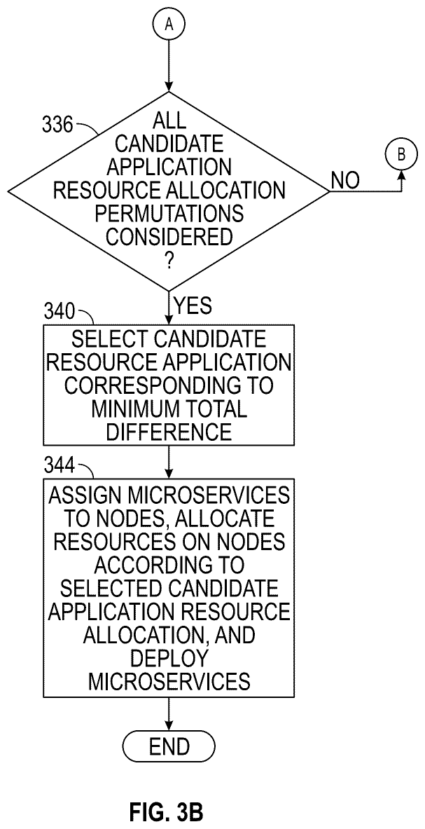

FIGS. 3A and 3B depict a flowchart of a technique 300 to determine an application resource allocation, in accordance with example implementations. The application resource allocation corresponds to a selection of compute node placements for microservices of a microservice-based application and further corresponds to resource allocations for the respective compute nodes. In an example, the technique 300 may be performed by an application resource allocation engine, such as the application resource allocation engine 184 (FIG. 1) or the application resource allocation engine 284 (FIG. 2).

Referring to FIG. 3A, the technique 300 includes an outer loop of iterations, where each iteration of the outer loop considers a particular candidate application resource allocation. Stated differently, the technique 300, for each iteration of the outer loop, evaluates a particular node placement and particular resource allocations for the nodes. For each iteration of the outer loop, the technique 300 performs an inner loop of iterations. The iterations of the inner loop are associated with respective requests of a set of requests for the application. The technique 300, for each iteration of the inner loop, determines an estimated QoE metric value and determines a difference between the estimated QoE metric value and a corresponding target QoE metric value.

The technique 300, pursuant to block 302, initializes parameters for the outer loop and then begins the outer loop by determining (block 304) the next candidate application resource allocation. For the particular candidate application resource allocation, the technique 300 includes initializing (block 308) the parameters for the inner loop. Each iteration of the inner loop includes blocks 312, 320 and 324 and is associated with a particular request of the set of potential requests processed by the application. Pursuant to block 312, the technique 300 determines the estimated QoS metric value for the request based on the candidate application resource allocation. Pursuant to block 320, the technique 300 determines the difference between the estimated QoS metric value and the target QoS metric value. The target QoS metric value is the value that is assigned to the request category corresponding to the request. The technique 300 then determines (decision block 324) whether there is another request of the set of requests to evaluate, and if not, another iteration of the inner loop is performed for the next request. Accordingly, the technique 300 includes selecting the next request, pursuant to block 328, and beginning another iteration of the inner loop starting at block 312.

If the technique 300 determines (decision block 324) that all requests of the set of requests have been evaluated, then the inner loop is complete, and pursuant to block 332, the technique 300 includes determining a total, or summation, of the inner loop-derived differences for the particular candidate application resource allocation. The summation of differences represents a degree of closeness, or fit, of the candidate application resource allocation to the set of target QoS metric values.

Referring to FIG. 3B in conjunction with FIG. 3A, the technique 300 includes determining (decision block 336) whether all candidate resource allocation permutations have been considered. If not, then the technique 300 begins another iteration of the outer loop to evaluate another candidate application resource allocation, and accordingly, control transitions to block 304 (FIG. 3A). If, pursuant to decision block 336, a determination is made that all candidate resource allocation permutations have been considered, then, pursuant to block 340, the technique 300 selects the candidate application resource allocation that corresponds to the minimum total difference.

In accordance with example implementations, the technique 300 may perform one or multiple actions responsive to the selection of an application resource allocation. In an example, pursuant to block 344, the technique 300 may deploy the microservices according to the application resource allocation. In this manner, the deployment includes, according to the application resource allocation, associating the microservices with the compute nodes. The deployment may further include configuring the compute nodes to have the resources specified by the application resource allocation. Moreover, the deployment may further include deploying containers to the compute nodes, where the containers include one or multiple container pods (e.g., pods corresponding to microservice instances) corresponding to the associated microservice. Additionally, the deployment may further include starting the containers.

In a more specific example, the QoE metric is a processing latency, and determining the application resource allocation is a minimization problem. More specifically, in the following discussion, the minimization problem is described using the symbols that are set forth below in Table 1:

TABLE 1

| Symbol | Description |
|---|---|
| R | Set of all requests under consideration at a given time. |
| Iᵣ | Set of micro-services of request r. |
| V | Set of edge servers. |
| Cᵢᵣ | Set of possible configurations for microservice i of request r. |
| Pᵢᵣ | Set of precedence microservices of microservice i of |
| | request r (this provides dependency information of |
| | microservices). |
| dᵣ | Latency deviation of request r. |
| eᵣ | Estimated completion time of request r. |
| τᵣ | Target completion time of request r. |
| tᵢᵣ | Transfer time of micro-service i of request r. |
| p_{irvc} | Estimated processing time of microservice i of request r |
| | served on node v with configuration c. |
| EP_{irvc} | Effective processing power of microservice i of request r |
| | using configuration c running on node v. |
| sᵢᵣ | Start time of microservice i of request r. |
| fᵢᵣ | Finish time of microservice i of request r. |
| fᵢᵣ | Finish time of the last microservice of request r. |
| y_{ircv} | Binary decision variable which is one if and only if |
| | microservice i of request r is using configuration c on node |
| | v. |
| xᵣ | Binary decision variable which is one if and only if request r |
| | is served and zero otherwise. |

A time-slotted environment is considered for the minimization problem. For each time slot, compute node resource allocations and compute node placement decisions are made. Received requests may be queued if the same request type was not considered in the previous time slot.

A request is associated with a collection of microservices that process, or serve, the request. A request is considered to be completed, or served, after all of the microservices of the collection are executed. Given that there exists precedence among the microservices, the completion time of request r is greater or equal to the finish time of the last microservice that serves the request. The finish time of a microservice of a request r is greater than the summation of the microservice's start time, a p_{irvc} processing time of the microservice and a transfer time tᵢᵣ of the response or output from that microservice to all of its dependent microservices.

In an example, the processing time p_{irvc} of a microservice is assumed to have a fixed time complexity related to the size of its input parameters without considering input/output (I/O) operations. Therefore, the processing time p_{irvc} of a microservice can be estimated using a regression model that is described below:

$${p}_{irvc} = {ρ}_{1} \times \frac{f ( Input )}{{EP}_{irvc} ( t )} + {ρ}_{2}$$

The processing time p_{irvc} corresponds to a specific microservice i, request r, compute node v and configuration c. Also, “f (Input)” represents the empirical time complexity of a microservice (e.g., a program) as a function of the size of the microservice's input data; “ρ₁” and “ρ₂” are regression coefficients used to incorporate other processing overhead such as I/O operations; and “EP_{irvc}” represents the effective processing power provided by configuration c of microservice i of request r when running on compute node v. The effective processing power EP_{irvc} corresponds to a specific microservice i, request r, compute node v and configuration c. In an example, the effective processing power EP_{irvc} is estimated by a linear function based on a number of CPU cores, a total random access memory (RAM) size and a total disk space, as described below:

$${EP}_{irvc} = {ω}_{1} {cpu}_{irvc} + {ω}_{2} {ram}_{irvc} + {ω}_{3} {disk}_{irvc}$$

In this equation, “ω₁,” ω₂,” and “ω₃” are hyper-parameters denoting the importance of CPU, RAM size and disk size in processing effectiveness of a compute node v.

A transfer time tᵢᵣ represents the time to transfer the output data of the executed microservice i of request r to all of its succeeding microservices. Assuming a uniform distribution of bandwidth among the compute nodes v, the transfer time tᵢᵣ depends on the size of output data for microservice i. In an example, the transfer time tᵢᵣ is determined as follows:

$${t}_{ir} = α \times {s}_{output}$$

In the foregoing equation, “sₒᵤₜₚᵤₜ” represents the size of the output of microservice i of request r.

The minimization problem involves minimizing the summation of the latency deviation dᵣ, as set forth below:

$$min {\sum }_{r ∈ R} {d}_{r}$$

In the foregoing equation, the notation “∀r∈R” means all requests r in the set of requests R are evaluated. The latency deviation dᵣ corresponds to the difference between the target and estimated QoE metric values for a particular request r, and the minimum summation corresponds to the minimization problem that is to minimize the latency deviation dᵣ for all requests in the system. The latency deviation dᵣ is defined as follows:

$${d}_{r} \geq {e}_{r} - {τ}_{r} ∀ r ∈ R$$

The minimization problem has the following constraint to ensure that the computer system resources are not over-provisioned so that estimated latency is always greater than or equal to target latency:

$${d}_{r} \geq 0 ∀ r ∈ R$$

This constraint indirectly ensures that the resource provider(s) minimize their costs by limiting over provisioning of resources. This is assuming that overprovisioning will reduce estimated latency.

Another constraint ensures that the completion time of request r is greater than or equal to the finish time of the last microservice of the request:

$${e}_{r} \geq {f}_{lr} + ( M - {f}_{lr} + {τ}_{r} ) \times ( 1 - {x}_{r} ) ∀ r ∈ R$$

The foregoing constraint also penalizes the system for not serving a request (i.e., when xᵣ=0). In this constraint, “M” is a fixed large number that corresponds to a penalty.

The minimization problem includes the following constraint to ensure that a microservice is started only when all of its precedence microservices have completed their executions:

$${s}_{ir} \geq {f}_{jr} ∀ i ∈ {I}_{r} , ∀ r ∈ R , ∀ j ∈ {P}_{ir}$$

In the foregoing constraint, the notation “∀i∈Iᵣ,” means all microservices i in the set of microservices Iᵣ that are associated with the request r are evaluated; and the notation “∀j∈Pᵢᵣ” means all precedence microservices for the request r are evaluated.

The following constraint sets the start time of the first microservice (i.e., the microservice corresponding to i=0) to zero for purposes of coordinating synchronization:

$${s}_{0 r} = 0 ∀ r ∈ R$$

The following constraint ensures that a request is served if all of its microservices are served, and otherwise, the request is not served:

$${x}_{r} \leq {\sum }_{v ∈ V} {\sum }_{c ∈ Cir} {y}_{ircv} ∀ i ∈ {I}_{r} , ∀ r ∈ R$$

For purposes of ensuring that for a particular request, each microservice associated with the request is served using a single configuration and only once, the following constraint is used:

$${\sum }_{v ∈ V} {\sum }_{c ∈ Cir} {y}_{ircv} \leq 1 ∀ i ∈ {I}_{r} , ∀ r ∈ R$$

In the foregoing constraint, the notation “v∈V” means that the outer summation is for all nodes v in the set of nodes V; and the notation “c∈Cir” means that the inner summation is for all configurations in the set Cir of configurations for the particular microservice i and request r.

The finish time fᵢᵣ of the last microservice of request r is determined based on the microservice's start time Sir, processing time p_{irvc} and transfer time tᵢᵣ, as described below:

$${f}_{ir} \geq {s}_{ir} + {\sum }_{v ∈ V} {\sum }_{c ∈ Cir} {p}_{irvcv} {y}_{ircv} + {t}_{ir} ∀ i ∈ {I}_{r} , ∀ r ∈ R$$

For purposes of preventing the total amount of CPU resources assigned to a node v from exceeding the node's CPU resource capacity, the following constraint is imposed:

$${\sum }_{i ∈ {I}_{r}} {\sum }_{r ∈ R} {\sum }_{c ∈ Cir} {cpu}_{c} {y}_{ircv} \leq {cpu}_{v} ∀ v ∈ V$$

In accordance with some implementations, for each resource (e.g., CPU, disk, and RAM) of the computer system a lower boundary l, an upper boundary u, and a step size s are defined, which determines the range of possible allocations for the resource. In an example, for purposes of allocating CPU resources, the lower boundary Icpu=1, the upper boundary ucpu=9, and the step size is s=2, which means for a given microservice at a given time step, the system can allocate one of the following number of CPU cores: 1, 3, 5, 7, 9.

For purposes of preventing the total amount of disk resources assigned to a node v from exceeding the node's disk space capacity, the following constraint is imposed:

$${\sum }_{i ∈ {I}_{r}} {\sum }_{r ∈ R} {\sum }_{c ∈ Cir} {disk}_{c} {y}_{ircv} \leq {disk}_{v} ∀ v ∈ V$$

For purposes of preventing the total amount of RAM resources assigned to a node v from exceeding the node's RAM space capacity, the following constraint is imposed:

$${\sum }_{i ∈ {I}_{r}} {\sum }_{r ∈ R} {\sum }_{c ∈ Cir} {ram}_{c} {y}_{ircv} \leq {ram}_{v} ∀ v ∈ V$$

The decision variables xᵣ and y_{ircv} are defined as follows:

$${x}_{r} , {y}_{ircv} ∈ \{ 0 , 1 \} , ∀ r ∈ R , ∀ i ∈ {I}_{r} , c ∈ {C}_{ir} , ∀ v ∈ V$$

In accordance with example implementations, the application resource allocation engine (e.g., the application resource allocation engine 184 of FIG. 1 or the application resource allocation engine 284 of FIG. 2) uses a linear programming solver to derive the node placements and configurations based on the constraints that are described herein. In accordance with further implementations, the application resource allocation engine includes a linear programming solver.

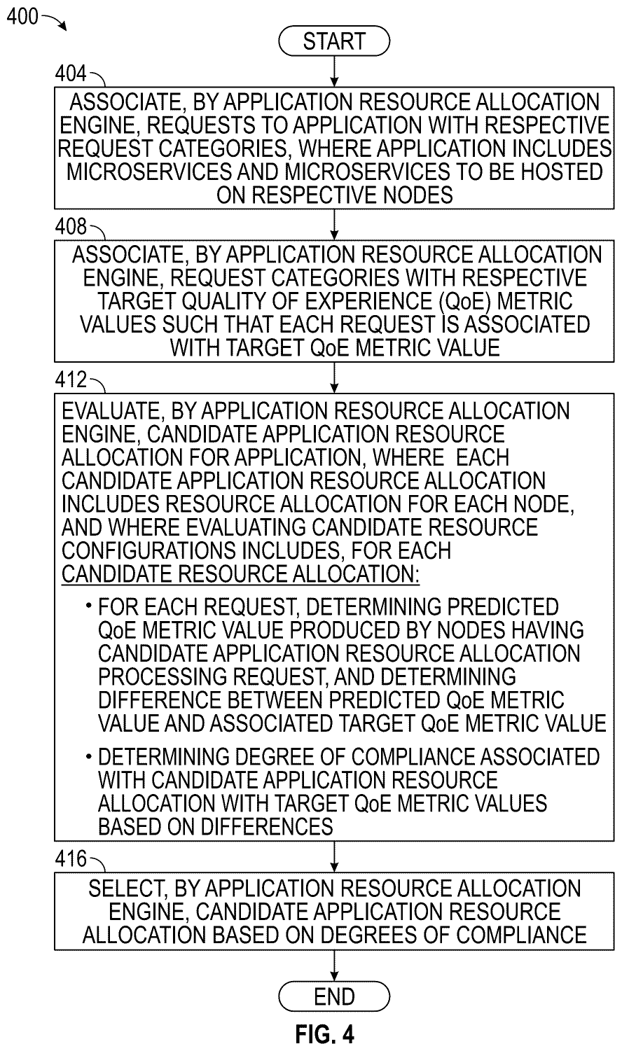

Referring to FIG. 4, in accordance with example implementations, a technique 400 includes associating (block 404), by an application resource allocation engine, requests to an application with respective request categories. The application includes microservices and the microservices are to be hosted on respective nodes. In an example, the nodes may be deployed on a distributed system. In another example, the nodes may be deployed on a cloud. In another example, the nodes may be deployed on an edge computing system. In example, a node corresponds to a bare-metal computing environment. In another example, a node corresponds to a server. In another example, a node corresponds to a virtual machine. In an example, a microservice corresponds to one or multiple container pods hosted by a node. In an example, the container pod(s) are deployed in a container that is hosted by the node.

In an example, the application resource allocation engine corresponds to one or multiple hardware processors executing machine-readable instructions. In another example, the application resource allocation engine is a hardware circuit that does not execute machine-executable instructions, such as an ASIC, FPGA, PLD or other hardware dedicated to providing one or multiple functions for the application resource allocation engine. In another example, the application resource allocation engine corresponds to a combination of one or multiple hardware processors executing machine-readable and a hardware circuit that does not execute machine-executable instructions. In another example, the application resource allocation engine may use or include a linear programming solver. In an example, the application resource allocation engine is associated with a resource provider. In an example, the application resource allocation engine is associated with an application resource allocation service.

The technique 400 includes associating (block 408), by the application allocation engine, the request categories with respective target QoE metric values such that each request of the requests is associated with a target QoE metric value. In an example, the QoE metric is a performance of the application as perceived or observed by an end user of the application. In an example, the target QoE metric is a processing latency. In another example, the target QoE metric is a throughput.

The technique 400 includes evaluating (block 412), by the application allocation engine, candidate resource allocations for the application. Each candidate application resource allocation includes a resource allocation for each node. In an example, a candidate resource allocation represents node placements for the microservices. In an example, the resource allocation for the node includes a compute resources allocation for the node. In an example, the resource allocation for the node includes a number of CPU cores for the node. In an example, the resource allocation for the node includes an amount of memory for the node. In an example, the resource allocation for the node includes an amount of RAM for the node. In an example, the resource allocation for the node includes a storage resource allocation for the node. In an example, the resource allocation for the node includes an amount of disk storage the node. In an example, the resource allocation for the node is an allocation of virtual resources. In an example, the resource allocation for the node is an allocation of physical resources.

Pursuant to block 412, evaluating the candidate resource allocations includes, for each candidate resource allocation and for each request of the requests, determining a predicted QoE metric value produced by the nodes having the candidate resource allocation processing the request, and determining a difference between the predicted QoE metric value and the associated target QoE metric value. In an example, determining the predicted QoE metric value includes estimating processing times by microservices processing the requests. In an example, estimating the processing time by a microservice includes applying a linear regression model. In an example, estimating the processing time by a microservice includes determining the processing time based on an empirical time complexity associated with the microservice. In an example, estimating the processing time by a microservice includes determining the processing time based on an effective processing power. In an example, the effective processing power is determined based on a configuration of the microservice. In an example, the effective processing power is determined based on the resource allocation of the node corresponding to the microservice. In an example, the effective processing power is determined based on a weighted combination of a number of CPU cores, a RAM size and a disk storage size. In an example, estimating the processing time by a microservice includes determining the processing time using one or multiple regression coefficients corresponding to processing overhead. In an example, determining the predicted QoE metric value includes estimating transfer times to transfer output data from microservices to succeeding microservices. In an example, estimating a transfer time includes determining a transfer time based on the size of an output provided by a microservice.

Pursuant to block 412, evaluating the candidate resource allocations includes, for each candidate resource allocation and for each request of the requests, determining a degree of compliance associated with the candidate resource allocation with the target QoE metric values based on the differences. In an example, the degree of compliance is a difference between the estimate and target QoE metric values.

In an example, evaluating the candidate resource allocations includes constraining the evaluation to prevent over-provisioning of resources. In an example, evaluating the candidate resource allocations includes constraining the evaluation to include a penalty for a request not being served. In an example, evaluating the candidate resource allocations includes constraining the evaluation to prevent the resources of a node from being overallocated.

The technique 400 includes, pursuant to block 416, selecting, by the application allocation engine, a candidate resource allocation from the candidate resource allocation based on the degrees of compliance. In an example, the degree of compliance is a difference between estimated and target QoE metric values; and selecting the candidate resource allocation includes adding the differences for each candidate resource allocation and adding the differences to provide a summation associated with the candidate resource allocation, and selecting the candidate resource allocation having the smallest associated summation. In an example, a recommendation of the selected candidate resource allocation is provided to a cloud service operator. In an example, the nodes are configured based on the selected candidate resource allocation.

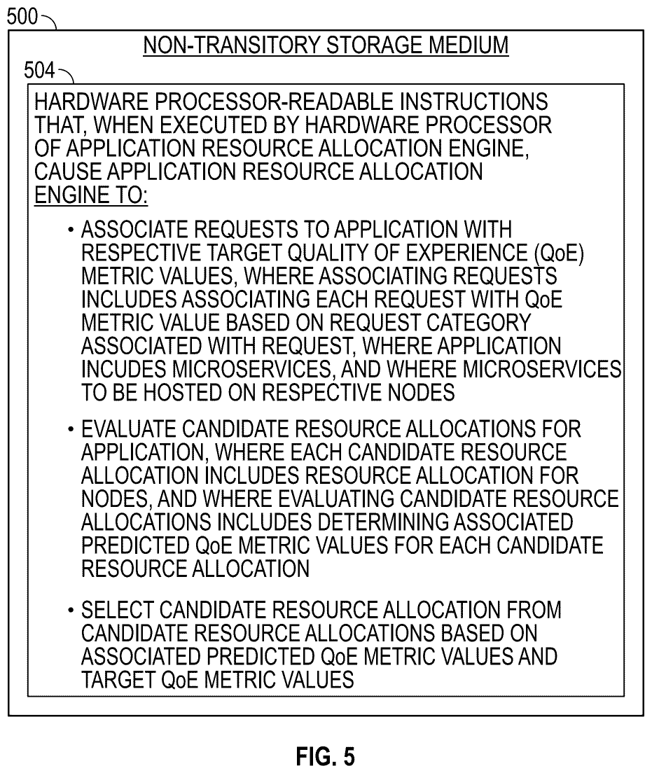

Referring to FIG. 5, in accordance with example implementations, a non-transitory storage medium 500 stores hardware processor-readable instructions 504.

The instructions 504, when executed by a hardware processor of an application resource allocation engine, cause the application resource allocation engine to associate requests to an application with respective target QoE metric values. In an example, the QoE metric is a performance of the application as perceived or observed by an end user of the application. In an example, the target QoE metric is a function of processing latency. In another example, the target QoE metric is a function of throughput.

Associating the requests includes associating each request with a QoE metric value based on a request category associated with the request. The application includes microservices, and the microservices to be hosted on respective nodes of a plurality of nodes. In an example, the nodes may be deployed on a distributed system. In another example, the nodes may be deployed on a cloud. In another example, the nodes may be deployed on an edge computing system. In example, a node corresponds to a bare-metal computing environment. In another example, a node corresponds to a server. In another example, a node corresponds to a virtual machine. In an example, a microservice corresponds to one or multiple container pods hosted by a node. In an example, the container pod(s) are deployed in a container that is hosted by the node.

The instructions 504, when executed by the hardware processor, further cause the application resource allocation engine to evaluate candidate resource allocations for the application. Each candidate resource allocation includes a resource allocation for the plurality of nodes. In an example, each candidate resource allocation further indicates a node placement for the respective microservices. In an example, the resource allocation for the node includes a compute resources allocation for the node. In an example, the resource allocation for the node includes a number of CPU cores for the node. In an example, the resource allocation for the node includes an amount of memory for the node. In an example, the resource allocation for the node includes an amount of RAM for the node. In an example, the resource allocation for the node includes a storage resource allocation for the node. In an example, the resource allocation for the node includes an amount of disk storage the node. In an example, the resource allocation for the node is an allocation of virtual resources. In an example, the resource allocation for the node is an allocation of physical resources.

Evaluating the candidate resource allocations includes determining associated predicted QoE metric values for each candidate resource allocation. In an example, determining a predicted QoE metric value includes estimating the predicted QoE metric value based on processing times and transfer times of the microservices for each request for the microservices that serve the request. In an example, estimating the processing time by a microservice includes applying a linear regression model. In an example, estimating the processing time by a microservice includes determining the processing time based on an empirical time complexity associated with the microservice. In an example, estimating the processing time by a microservice includes determining the processing time based on an effective processing power. In an example, the effective processing power is determined based on a configuration of the microservice. In an example, the effective processing power is determined based on the resource allocation of the node corresponding to the microservice. In an example, the effective processing power is determined based on a weighted combination of a number of CPU cores, a RAM size and a disk storage size. In an example, estimating the processing time by a microservice includes determining the processing time using one or multiple regression coefficients corresponding to processing overhead. In an example, determining the predicted QoE metric value includes estimating transfer times to transfer output data from microservices to succeeding microservices. In an example, estimating a transfer time includes determining a transfer time based on the size of an output provided by a microservice.

The instructions 504, when executed by the hardware processor, further cause the application resource allocation engine to select a candidate resource allocation from the candidate resource allocations based on the associated predicted QoE metric values and the target QoE metric values. In an example, a recommendation of the selected candidate resource allocation is provided to cloud service operator. In an example, the nodes are configured based on the selected candidate resource allocation.

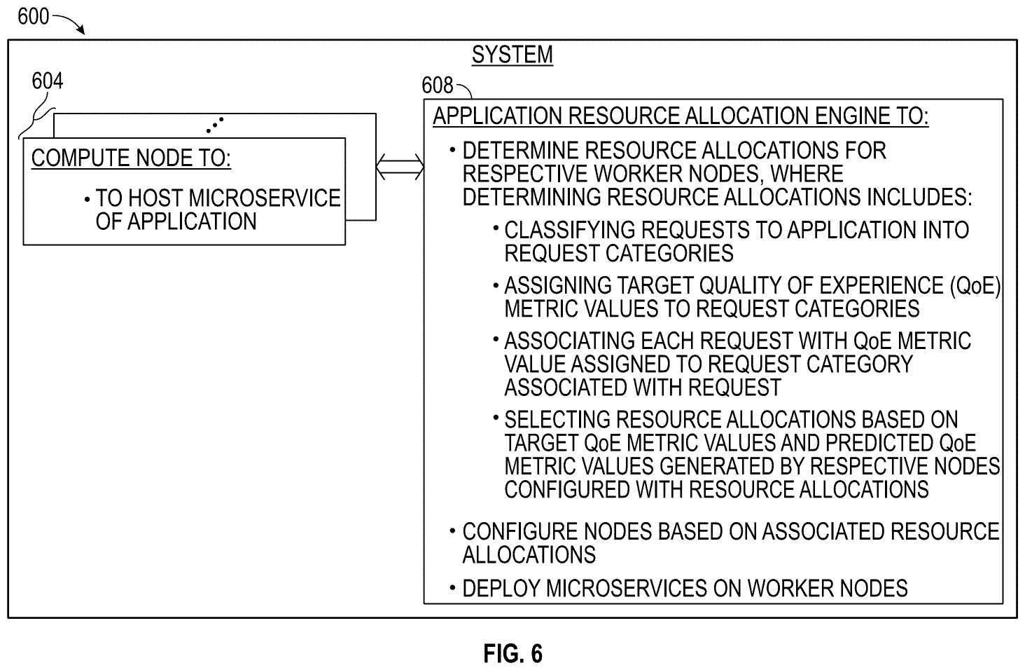

Referring to FIG. 6, in accordance with example implementations, a system 600 includes a plurality of compute nodes 604 and an application resource allocation engine 608. The compute nodes 604 are to host respective microservices of an application. In an example, the nodes may be deployed on a distributed system. In another example, the nodes may be deployed on a cloud. In another example, the nodes may be deployed on an edge computing system. In example, a node corresponds to a bare-metal computing environment. In another example, a node corresponds to a server. In another example, a node corresponds to a virtual machine. In an example, a microservice corresponds to one or multiple container pods hosted by a node. In an example, the container pod(s) are deployed in a container that is hosted by the node.

The application resource allocation engine 608 determines resource allocations for respective compute nodes 604. In an example, the resource allocations include respective numbers of CPU cores. In an example, the resource allocations include respective memory allocations, such as respective RAM allocations. In an example, the resource allocations include respective storage resource allocations, such as respective disk storage allocations. In an example, the resource allocations include virtual resource allocations. In another example, the resource allocations include physical resource allocations.

Determining the resource allocations includes classifying requests to the application into request categories; and assigning target QoE metric values to the request categories. In an example, the QoE metric is a function of processing latency. In another example, a QoE metric is a function of throughput. Determining the resource allocations further includes associating each request of the request categories with the QoE metric value assigned to the request category associated with the request; and selecting the resource allocations based on the target QoE metric values and predicted QoE metric values generated by the respective nodes configured with the resource allocations.

The application resource allocation engine 608 further configures the compute nodes 604 based on the associated resource allocations; and deploys the microservices on the compute nodes 604. In an example, deploying the microservices on the compute nodes includes deploying a container that corresponds to a given microservice on a compute node 604 and starting the container. In an example, the container includes container pods that correspond to instances of the given microservice.

In accordance with example implementations, deploying the application includes configuring the nodes so that the nodes have the selected candidate resource allocation. Among the potential advantages, compute node placements and compute node resource allocations may be determined for a microservice-based application without requiring detailed knowledge about the inner workings of the application.

In accordance with example implementations, the nodes are respective virtual machines. Deploying the application further includes, for a given virtual machine, configuring virtual resources of the given virtual machine based on the selected candidate resource allocation. Among the potential advantages, compute node placements and compute node resource allocations may be determined for a microservice-based application without requiring detailed knowledge of the inner workings about the application.

In accordance with example implementations, deploying the application further includes deploying containers of respective nodes. Each container includes a container pod that corresponds to the microservice hosted on the respective node. Among the potential advantages, compute node placements and compute node resource allocations may be determined for a microservice-based application without requiring detailed knowledge of the inner workings of the application.

In accordance with example implementations, the target QoE metric values include target processing times for the respective request, and the predicted QoE metric values include predicted processing times for the respective request. Among the potential advantages, compute node placements and compute node resource allocations may be determined for a microservice-based application without requiring detailed knowledge of the inner workings of the application.

In accordance with example implementations, determining the degree of compliance includes determining a summation of the differences. Among the potential advantages, compute node placements and compute node resource allocations may be determined for a microservice-based application without requiring detailed knowledge of the inner workings of the application.

In accordance with example implementations, the evaluation is constrained to remove a candidate resource allocation from consideration based on the associated degree of compliance being less than or equal to zero. Among the potential advantages, compute node placements and compute node resource allocations may be determined for a microservice-based application without requiring detailed knowledge of the inner workings of the application.

In accordance with example implementations, selecting the candidate resource allocation includes selecting the minimum degree of compliance among the degrees of compliance. Among the potential advantages, compute node placements and compute node resource allocations may be determined for a microservice-based application without requiring detailed knowledge of the inner workings of the application.

In accordance with example implementations, selecting the candidate resource allocation includes selecting, for a given node, at least one of a number of processing cores, a memory allocation or a storage allocation for the given node. Among the potential advantages, compute node placements and compute node resource allocations may be determined for a microservice-based application without requiring detailed knowledge of the inner workings of the application.

In accordance with example implementations, the evaluation is constrained based on resource capacities of the nodes. Among the potential advantages, compute node placements and compute node resource allocations may be determined for a microservice-based application without requiring detailed knowledge of the inner workings of the application.

In accordance with example implementations, determining the predicted QoE metric value includes determining a processing time for a given microservice based on a size of an input of the given microservice and an effective processing power of the given microservice. Among the potential advantages, compute node placements and compute node resource allocations may be determined for a microservice-based application without requiring detailed knowledge of the inner workings of the application.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
associating, by an application resource allocation engine, requests to an application with respective request categories, wherein the application comprises microservices and the microservices to be hosted on respective nodes;
associating, by the application allocation engine, the request categories with respective target Quality-of-Experience (QoE) metric values such that each request of the requests is associated with a target QoE metric value of the target QoE metric values;
evaluating, by the application allocation engine, candidate resource allocations for the application, wherein each candidate application resource allocation of the candidate resource allocations comprises a resource allocation for each node of the nodes, and wherein evaluating the candidate resource configurations comprises, for each candidate resource allocation:
for each request of the requests, determining a predicted QoE metric value produced by the nodes having the candidate resource allocation processing the request, and determining a difference between the predicted QoE metric value and the associated target QoE metric value; and
determining a degree of compliance associated with the candidate resource allocation with the target QoE metric values based on the differences; and
selecting, by the application allocation engine, a candidate resource allocation from the candidate resource allocation based on the degrees of compliance.

2. The method of claim 1, further comprises deploying the application, wherein deploying the application comprises, configuring the nodes so that the nodes have the selected candidate resource allocation.

3. The method of claim 2, wherein:
the nodes comprise respective virtual machines; and
deploying the application further comprises for a given virtual machine of the virtual machines, configuring virtual resources of the given virtual machine based on the selected candidate resource allocation.

4. The method of claim 2, wherein deploying the application further comprising deploying containers on respective nodes of the nodes, wherein each container comprises a container pod corresponding to the microservice hosted on the respective node.

5. The method of claim 1, wherein:
the target QoE metric values comprise target processing times for the respective requests; and
the predicted QoE metric values comprise predicted processing times for the respective requests.

6. The method of claim 1, wherein determining the degree of compliance of the candidate resource allocation comprises determining a summation of the differences.

7. The method of claim 1, further comprising constraining the evaluation to remove a candidate resource allocation from consideration based on the associated degree of compliance being less than or equal to zero.

8. The method of claim 1, wherein selecting the candidate resource allocation comprises selecting the minimum degree of compliance among the degrees of compliance.

9. The method of claim 1, wherein selecting the candidate resource allocation comprises selecting, for a given node of the nodes, at least one of a number of processing cores, a memory allocation or a storage allocation for the given node.

10. The method of claim 1, further comprising constraining the evaluation based on resource capacities of the nodes.

11. The method of claim 1, wherein:
determining the predicted QoE metric value comprises determining a processing time for a given microservice of the microservices based on a size of an input to the given microservice and an effective processing power of the given microservice.

12. A non-transitory storage medium that stores hardware processor-readable instructions that, when executed by a hardware processor of an application resource allocation engine, cause the application resource allocation engine to:
associate requests to an application with respective target Quality-of-Experience (QoE) metric values, wherein associating the requests comprises associating each request of the requests with a QoE metric value of the QoE metric values based on a request category associated with the request, wherein the application comprises microservices, and wherein the microservices to be hosted on respective nodes of a plurality of nodes;
evaluate candidate resource allocations for the application, wherein each candidate resource allocation comprises a resource allocation for the plurality of nodes, and wherein evaluating the candidate resource allocations comprises determining associated predicted QoE metric values for each candidate resource allocation; and
select a candidate resource allocation from the candidate resource allocations based on the associated predicted QoE metric values and the target QoE metric values.

13. The storage medium of claim 12, wherein the instructions, when executed by the hardware processor, further cause the application allocation engine to further to model a given request of the requests as a directed graph comprising vertices corresponding to microservices of the microservices of the application which process the given request.

14. The storage medium of claim 13, wherein the instructions, when executed by the hardware processor, further cause the application allocation engine to further generate an adjacency matrix representing the directed graph, wherein each element of the adjacency matrix has a state representing whether a pair of microservices of the microservices of the application are dependent.

15. The storage medium of claim 12, wherein:
the target QoE metric values comprise target processing times for the respective requests; and
the predicted QoE metric values comprise predicted processing times for the respective requests.

16. The storage medium of claim 12, wherein the instructions, when executed by the hardware processor, further cause the application allocation engine to further:
for each candidate resource allocation of the candidate resource allocations:
determine, for each request of the request, a difference between a target processing time for the nodes to process the request and a predicted processing time; and
determine a summation of the differences; and
select the selected candidate resource allocation based on the associated summation.

17. A system comprising:
a plurality of compute nodes to host respective microservices of an application;
an application resource allocation engine to:
determine resource allocations for respective compute nodes of the plurality of compute nodes, wherein determining the resource allocations comprises:
classifying requests to the application into request categories;
assigning target Quality-of-Experience (QoE) metric values to the request categories;
associating each request of the request categories with the QoE metric value assigned to the request category associated with the request; and
selecting the resource allocations based on the target QoE metric values and predicted QoE metric values generated by the respective nodes configured with the resource allocations;
configure the nodes based on the associated resource allocations; and
deploy the microservices on the compute nodes.

18. The system of claim 17, further comprising an orchestrated container cluster comprising the plurality of compute nodes.

19. The system of claim 17, wherein a given compute node of the plurality of compute nodes comprises a container, and the container is deployed on one of a virtual machine or a bare-metal machine.

20. The system of claim 17, wherein the resource allocations for a given compute node of the plurality of compute nodes comprise at least one of an allocation of processing cores, an allocation of memory or an allocation of storage.
